(19) United States
(12) Patent Application Publication
(10) Pub. No.: US 2006/0060073 A1
(43) Pub. Date: Mar. 23, 2006

(54) Apparatus and method for replicating sounds and feelings associated with the release of gas from the human body

(76) Inventor: Gary Wendt, Font du Lac, WI (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/232,837

(22) Filed: Sep. 22, 2005

Related U.S. Application Data
(60) Provisional application No. 60/612,077, filed on Sep. 22, 2004.

(51) Int. Cl. G10H 3/00; G10H 1/32

(52) U.S. Cl. 84/743

(57) ABSTRACT

An apparatus and method for replicating sounds and feelings typically associated with the release of gas from the human body are disclosed. The apparatus may include a rigid member, an elastic member, and a rigid object. The method includes winding the rigid object, placing the apparatus beneath a person's upper thigh and/or buttocks, and releasing the coiled rigid object such that sound and feelings are generated that are similar to the sounds and feelings commonly associated with the release of gas from the human body. The apparatus and method are intended to elicit humor, laughter, amusement, and/or embarrassment. The apparatus and method are also intended to be inexpensive, portable, and easy to carry.

### CROSS-REFERENCE TO RELATED APPLICATION

This application claims priority to copending U.S. provisional application entitled “APPARATUS AND METHOD FOR REPLICATING SOUNDS AND FEELINGS ASSOCIATED WITH THE RELEASE OF GAS FROM THE HUMAN BODY” filed Sep. 22, 2004 and having application Ser. No. 60/612,077, which is entirely incorporated herein by reference.

### BACKGROUND OF THE INVENTION

1. Field of the Invention

This invention generally relates to an apparatus and method for simulating sounds and feelings commonly associated with the release of gas from a human being. The replicated sounds and feelings are particularly directed to the release of gas from a person's lower intestinal region, but may also be used to replicate the sounds and feelings associated with the release of gas from a person's mouth.

2. Description of Background Art

The purpose of certain novelty noisemakers, which have been around for some time, is to entertain, embarrass, and amuse those that use the novelty device and/or those that are present during its use. The passing of gas is a human bodily function long considered impolite in the presence of others, thus creating the circumstance for amusement or embarrassment.

Novelty or gag devices such as this are commonly sold in stores, the Internet or on television. Many of these devices have become extremely well known such as the “Whoopie Cushion” and the “Pet Rock.” To applicant's knowledge, however, the prior art fails to teach or suggest the apparatus and method for replicating the sounds and feelings associated with the release of gas from the human body that are disclosed herein.

### SUMMARY OF THE INVENTION

An inventive aspect of the present invention provides a unique method for replicating sounds and feelings associated with the release of gas from the human body.

Another inventive aspect of the present invention provides a unique apparatus for replicating sounds and feelings associated with the release of gas from the human body.

Another inventive aspect of the invention provides a simple and inexpensive apparatus and method for replicating the sounds and feelings associated with the release of gas from the human body.

Another inventive aspect of the invention is to provide an apparatus and method that elicits humor, laughter, amusement, and/or embarrassment.

Another inventive aspect of the invention is an apparatus and method that is portable and easy to carry.

These and other advantages and features of the present invention may be discerned from reviewing the accompanying drawings and the detailed description of the invention.

### BRIEF DESCRIPTION OF THE DRAWINGS

The present invention may take form in various components and arrangements of components and in various steps and arrangement of steps. The drawings are only for purposes of illustrating a representative embodiment and is not to be construed as limiting the invention.

FIG. 1 is a top view of a preferred apparatus embodiment of the present invention.

FIG. 2 is a flowchart of a preferred method of the present invention.

### DETAILED DESCRIPTION OF A REPRESENTATIVE EMBODIMENT OF THE INVENTION

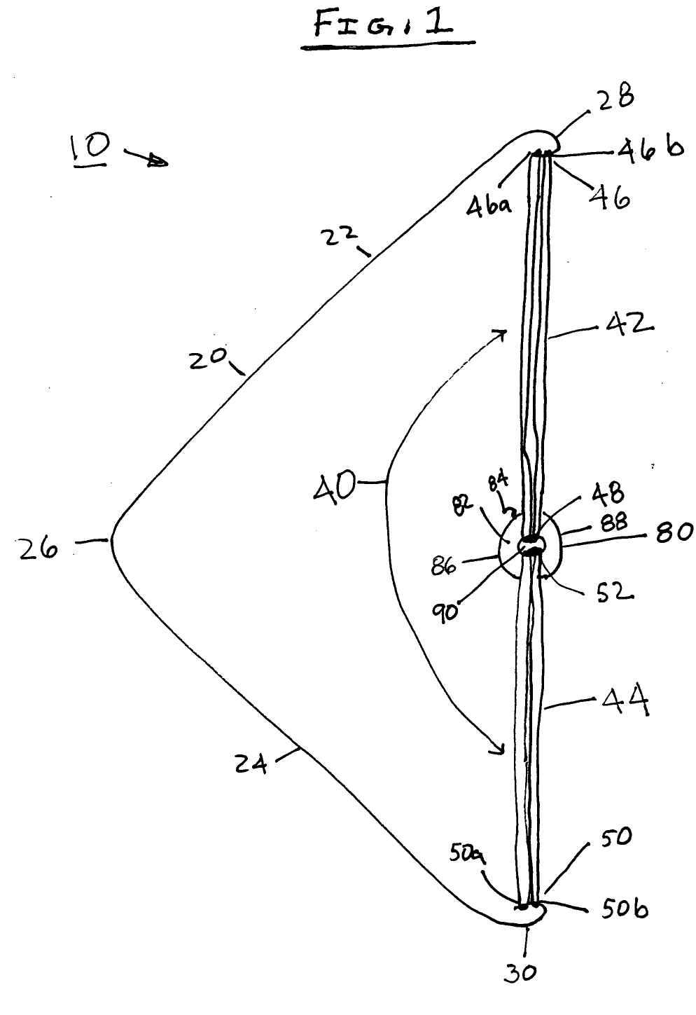

An apparatus for the replication of sounds and feelings associated with the release of gas from the human body is shown in FIG. 1. The apparatus (10) includes a rigid member (20), an elastic member (40), and a rigid object (80).

Rigid member (20) may include a first leg (22) and a second leg (24). First leg (22) and second leg (24) preferably meet at intersection (26). First leg (22) may also include an end (28) that is shaped so that it can receive and hold a portion of elastic member (40). Likewise, second leg (24) may also include an end (30) that is shaped so that it can receive and hold a portion of elastic member (40).

Rigid member (20) may be made from any rigid material such as metal, plastic, rubber, composites, ceramics, wood, etc. Rigid member (20) may also comprise more than one type of material. For example, first leg (22) and second leg (24) may be made of metal, while ends (28) and (30) may be made from a different material such as plastic or rubber. Intersection (26) may also be formed from a material that is different from the materials of legs (22) and (24). For example, intersection (26) may be made from flexible plastic or rubber so that the angle between legs (22) and (24) is adjustable.

A portion of metal removed from a coat hanger has been found to be a suitable source for the creation of rigid member (20). The metal found in a typical coat hanger is rigid enough to secure and hold the elastic member (40) yet it is soft enough to allow for the angle adjustment of legs (22) and (24).

Elastic member (40) may include a first section (42) and a second section (44). First section (42) has a first end (46) and a second end (48). Likewise, second section (44) also has a first end (50) and a second end (52). First end (46) and second end (50) are able to engage the ends (28) and (30) of first leg (22) and second leg (24), respectively, of rigid member (20).

Two rubber bands may be used to form elastic member (40). In this embodiment, a first rubber band forms first section (42) of elastic member (40). A first end (46a) of the first rubber band (42) is connected to first end (28) of leg (22). The mid-section (48) of the rubber band engages rigid object (80). A second end (46b) of the first rubber band (42) is also connected to first end (28) of leg (22). Similarly, a second rubber band may form second section (44) of elastic member (40). A first end (50a) of the second rubber band (44) is connected to second end (30) of leg (24). The mid-section (52) of the second rubber band engages rigid object (80). A second end (50b) of the second rubber band (44) is also connected to second end (30) of leg (24).

Rigid object (80) includes a first side (82), a second side (84), a first edge (86), and a second edge (88). Rigid object (80) is connected to elastic member (40). Rigid object (80) is made of a material rigid enough to allow it to be twisted or wound about elastic member (40). Rigid object (80) may be coiled by twisting or winding rigid object (80) about elastic member (40).

A washer may be used to form rigid member (80). If a washer is used as rigid member (80), mid-section (48) of a first rubber band (42) passes through and engages opening (90) of washer (80) and mid-section (52) of a second rubber band (44) also passes through and engages opening (90) of washer (80).

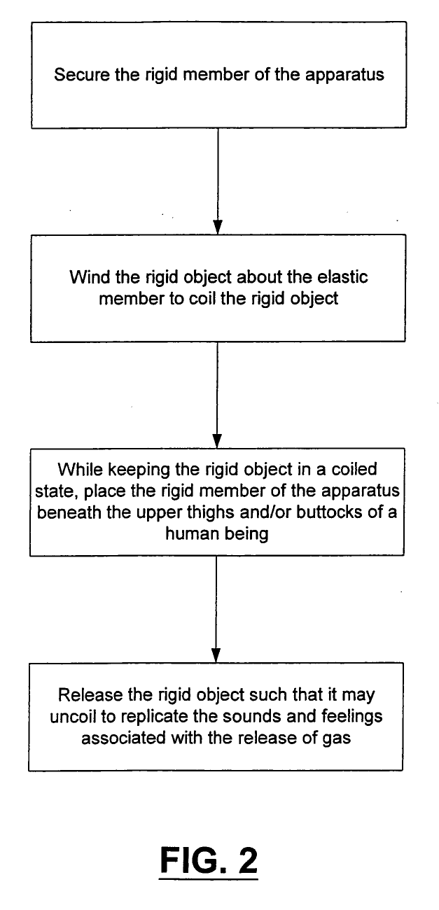

A method for the replication of sounds and feelings associated with the release of gas from the human body is shown in FIG. 2. Step 1 is to secure the rigid member (20) of the apparatus (10). Step 2 is to twist, wind, or coil rigid object (80) about elastic member (40) to coil or spring-load rigid object (80). Step 3, while keeping the rigid object in a coiled or spring-loaded state, is to place rigid member (20) beneath the upper thighs and/or buttocks of a human being who is sitting down. Preferably, intersection (26) is placed beneath a persons upper thighs and/or buttocks. In step 4, rigid object (80) is released such that it may uncoil or unwind about elastic member (40). If necessary to assist the uncoiling and unwinding of rigid object (80), the user of apparatus (10) may lean to one side, or lean backwards or forwards, until enough space is formed between the upper thighs and/or buttocks and rigid object (80) to thereby release the tension in elastic member (40) and uncoil and unwind rigid object (80).

As rigid object (80) uncoils about elastic member (40) sounds are generated that replicate sounds typically associated with the release of gas from a human being. In addition, as rigid object (80) uncoils about elastic member (40) feelings or sensations are also generated that replicate feelings and sensations typically associated with the release of gas from a human being.

It will be understood and appreciated by those skilled in the art, that apparatus (10) will replicate similar sounds and feelings by allowing rigid member (80) to uncoil or unwind while rigid member (80) is in contact with any device or material such as paper, wood, etc. In other words, replicating sounds can be generated by means other than by placing apparatus (10) between a person's upper thighs and/or buttocks and the structure supporting that person's upper thighs and/or buttocks.

While the present invention has been illustrated by the description of a representative embodiment and method, it is not the intention of the applicant to restrict or in any way limit the scope of the appended claims to such detail. Additional advantages and modifications will readily appear to those skilled in the art. The invention in its broadest aspects is therefore not limited to the specific details, representative embodiment, and illustrative examples shown and described. Accordingly, departures may be made from such details without departing from the spirit or scope of applicant's general inventive concept.

What is claimed is:

1. An apparatus for replicating sounds and feelings associated with the release of gas from a human being comprising:
a rigid member having a first leg and a second leg; said first leg and said second leg each having an end;
a first elastic member having a first end and a second end;
a second elastic member having a first end and a second end;
a rigid object;
said first and said second ends of said first elastic member are connected to said end of said first leg;
said first and said second ends of said second elastic member are connected to said end of said second leg;
wherein said rigid member interconnects said first and said second elastic members and said rigid member is able to rotate such that a sound is produced that replicates the sound of gas being released from a human being.

2. The apparatus of claim 1, wherein said first elastic member passes through a hole in said elastic member.

3. The apparatus of claim 2, wherein said second elastic member passes through a hole in said elastic member.

4. The apparatus of claim 1, wherein said rigid member rotates about an axis formed along a line extending from said end of said first leg and said end of said second leg.

5. The apparatus of claim 1, wherein said first leg and said second leg further comprise second ends.

6. The apparatus of claim 5, wherein said second ends of said first and said second leg meet to form an intersection.

7. The apparatus of claim 5, wherein said intersection formed by said second ends of said first and said second leg forms an approximate angle of ninety degrees.

8. The apparatus of claim 5, wherein said intersection formed by said second ends of said first and said second leg forms an approximate angle of forty-five degrees.

9. The apparatus of claim 5, wherein said intersection formed by said second ends of said first and said second leg forms an approximate angle of one hundred thirty-five degrees.

10. The apparatus of claim 5, wherein said intersection formed by said second ends of said first and said second leg forms an adjustable angle.

11. An apparatus for replicating sounds and feelings associated with the release of gas from a human being comprising:
a rigid member;
an elastic member; and
a rigid object.

12. A method for replicating sounds and feelings associated with the release of gas from a human being comprising the steps of:
securing a rigid member;
twisting a rigid object about an elastic member;
releasing the twisted rigid object such the rigid object generates sounds and feelings that replicate the release of gas by a human being.
